(19) United States
(12) Patent Application Publication
(10) Pub. No.: US 2011/0288914 A1
(43) Pub. Date: Nov. 24, 2011

(54) METHOD AND SYSTEM FOR PROVIDING ADVERTISING IN A VIRTUAL ENVIRONMENT

(76) Inventor: Brett James Guthrie, Langwarrin (AU)

(21) Appl. No.: 13/102,271

(22) Filed: May 6, 2011

Related U.S. Application Data
(60) Provisional application No. 61/332,282, filed on May 7, 2010.

(51) Int. Cl. G06Q 30/00

(52) U.S. Cl. 705/14.4

(57) ABSTRACT

A method of providing advertising in a virtual environment comprising:
electronically associating at least one event at a location within said virtual environment;
electronically facilitating provision of advertising within said virtual environment; and
displaying said advertising to patrons of said virtual environment when said patrons traverse the virtual environment to arrive at the location of the at least one event to access the at least one event.

This application claims priority from U.S. Provisional Patent Application 61/332,282, filed May 7, 2010, incorporated herein by reference.

### FIELD OF THE INVENTION

The present invention relates to a method and system for providing advertising in a virtual environment and relates particularly but not exclusively to displaying advertisement to patrons of a virtual environment such as a virtual stadium.

### BACKGROUND

Example of existing electronic advertising would typically be in the form of banners, pop-ups and the like being displayed on Internet accessible web pages. In addition, existing electronic advertising may be in the form of banners and the like being displayed in an electronic game. However, such examples of advertising can be inefficient at converting viewers (e.g. in the case of web page traffic) of the advertising into sales for the advertised goods and services, and or inefficient at attracting viewers (e.g. in the case of game traffic). The net effect of this is a low advertising efficacy, which, in turn, creates pressure on data aggregation because large volumes of traffic are required to create meaningful advertising returns for the advertisers.

### STATEMENTS OF THE INVENTION

According to one aspect of the invention there is provided a method of providing advertising in a virtual environment comprising:

electronically associating at least one event at a location within said virtual environment;

electronically facilitating provision of advertising within said virtual environment; and

displaying said advertising to patrons of said virtual environment when said patrons traverse the virtual environment to arrive at the location of the at least one event to access the at least one event.

In one example, the method includes displaying the advertising upon the patrons entering the virtual environment. For example, a patron may visit an Internet accessible web page displaying a virtual environment (e.g. a virtual stadium) to view an event (e.g. a pre-recorded game) located in the virtual environment, select to enter the virtual environment, and subsequently view advertising displayed within the virtual environment en route to the location of the desired event (e.g. location of the pre-recorded game). In the example, the provision of advertising in a virtual environment facilitates monetizing, via virtual advertising, of content provided by the virtual environment, such as sporting content, without requiring the subscription of patrons which may negatively impact on traffic.

In one example, the virtual environment comprises a virtual stadium which may be three dimensional.

In one example, the method includes electronically associating advertising at discrete locations within the virtual environment. For example, the patron may view advertising in the form of different advertisements located at different locations in the virtual environment whilst en route to the location of a required event. In another example, each advertisement comprises a virtual shop (e.g. a shop having purchase facilities) at discrete locations in the virtual environment. In yet another example, a plurality of virtual shops forms a virtual shopping centre, or a virtual shopping precinct within the virtual environment.

In one example, the method includes displaying selected ones of said plurality of different advertisements at different locations in the virtual environment. For example, a plurality of different advertisements may be stored and selected to be displayed to the patron according to the nature of the required event (e.g. sporting apparel advertisements are displayed if the patron wishes to view a pre-recorded sporting event), or the nature of the patron (e.g. advertisements are displayed based on the patron's registered interests).

In one example, the method includes electronically associating each event at discrete locations within the virtual environment. In the example of a virtual stadium, the events include multiple pre-recorded games so a patron can select a desired pre-recorded game based on the location of the game within the virtual stadium. In the example, the method includes displaying virtual shops at discrete locations in the virtual environment to the patrons traversing the virtual environment to arrive at a location of a required one of the events. Alternatively, more than one event can be associated at a single location.

In one example, the events include a league ladder and league fixtures for games played at the virtual stadium. In addition, the events may include both live and pre-recorded games played at the virtual stadium, as well as other events associated with the virtual stadium, such as player statistics, etc.

It is to be appreciated by those persons skilled in the art that a virtual environment may exist in the virtual domain only or may be a virtual representation of a physical environment. In the example of a virtual stadium, the virtual stadium may exist only virtually and is used to host patrons of virtual games or the virtual stadium may be a virtual representation of a physical stadium used to host physical games that are recorded for subsequent viewing in the virtual environment.

According to another aspect of the invention there is provided a system for providing advertising in a virtual environment comprising:

a server providing said virtual environment, the server being connected via a network to remote computer devices,

an association module arranged to associate at least one event at a location within said virtual environment;

an advertising module arranged to facilitate provision of advertising within said virtual environment, wherein said advertising module is further arranged to display said advertising to patrons of said virtual environment using said remote computer devices to traverse the virtual environment to arrive at the location of the at least one event to access the at least one event.

According to another aspect of the invention there is provided a computer program code which when executed implements the above method.

According to another aspect of the invention there is provided a tangible computer readable medium comprising the above computer program code.

According to another aspect, the invention extends to transmitting the above computer program code.

According to another aspect of the invention there is provided a data signal comprising the above computer program code.

### BRIEF DESCRIPTION OF THE DRAWINGS

In order that the invention can be clearly ascertained examples of embodiments will now be described with reference to the accompanying drawings wherein:

FIG. 1 is a functional flow diagram of a method of advertising in a virtual environment according to an embodiment of the present invention,

FIG. 2 is a schematic diagram of a system for advertising in a virtual environment according to an embodiment of the present invention,

FIG. 3 is a system architecture diagram of a system for implementing the method of FIG. 1 according to an embodiment of the present invention,

FIG. 4 is a further functional flow diagram of the method of FIG. 1,

FIG. 5 is a further functional flow diagram of the method of FIG. 1 showing steps for generating a virtual environment,

FIG. 6 is a further functional flow diagram of the method of FIG. 1 showing steps for administrating a virtual environment,

FIG. 7 is a further functional flow diagram of the method of FIG. 1 showing steps for advertising in a virtual environment,

FIG. 8 is a further functional flow diagram of the method of FIG. 1 showing steps for using a virtual environment,

FIG. 9 is an exemplary screen display according to an embodiment of the present invention,

FIG. 10 is a further exemplary screen display according to the embodiment of FIG. 9,

FIG. 11 is a further exemplary screen display according to the embodiment of FIG. 9,

FIG. 12 is a further exemplary screen display according to the embodiment of FIG. 9,

FIG. 13 is a further exemplary screen display according to the embodiment of FIG. 9,

FIG. 14 is a further exemplary screen display according to the embodiment of FIG. 9,

FIG. 15 is a further exemplary screen display according to the embodiment of FIG. 9,

FIG. 16 is a further exemplary screen display according to the embodiment of FIG. 9,

FIG. 17 is a plurality of exemplary screen displays according to the embodiment of FIG. 9,

FIG. 18 is a system architecture diagram of a system for event recording and playback for use with the embodiment of FIG. 1,

FIG. 19 is a functional flow diagram showing example of steps used to implement the system of FIG. 18,

FIG. 20 is a functional flow diagram of detail of the steps of FIG. 19,

FIG. 21 is a functional flow diagram of detail of the steps of FIG. 19,

FIG. 22 is a functional flow diagram of further detail of the steps of FIG. 19,

FIG. 23 shows a screen display used in a Registration process according to the embodiment of FIG. 18,

FIG. 24 shows an exemplary screen display used in setting up a Team channel according to the embodiment of FIG. 18,

FIG. 25 shows an exemplary screen display of a home screen according to the embodiment of FIG. 18,

FIG. 26 shows an exemplary screen display used to order an individual event (e.g. video) according to the embodiment of FIG. 18,

FIG. 27 is a schematic diagram of process steps taken in the ordering of an individual event when defining start and end times according to the embodiment of FIG. 18,

FIG. 28 is a screen display used when choosing a label for an individual event according to the embodiment of FIG. 18,

FIG. 29 is an exemplary screen display for providing a voice overlay or mark-up according to the embodiment of FIG. 18,

FIG. 30 shows a start button arrangement for voice recording according to the embodiment of FIG. 18,

FIG. 31 is an exemplary screen display of a library of individual events and a player device according to the embodiment of FIG. 18,

FIG. 32 is an exemplary screen display similar to that in FIG. 31 and showing the way mark ups may be entered according to the embodiment of FIG. 18, and

FIG. 33 is a functional flow diagram of further detail of the steps of FIG. 19.

### DETAILED DESCRIPTION

According to the embodiment, there is provided a method 10 of providing advertising in a virtual environment as shown in FIG. 1. The method 10 includes the steps of electronically associating 12 at least one event at a location within a virtual environment, electronically facilitating 14 provision of advertising within the virtual environment, and displaying 16 advertising to patrons of the virtual environment when the patrons traverse the virtual environment to arrive at the location of the at least one event to access the at least one event.

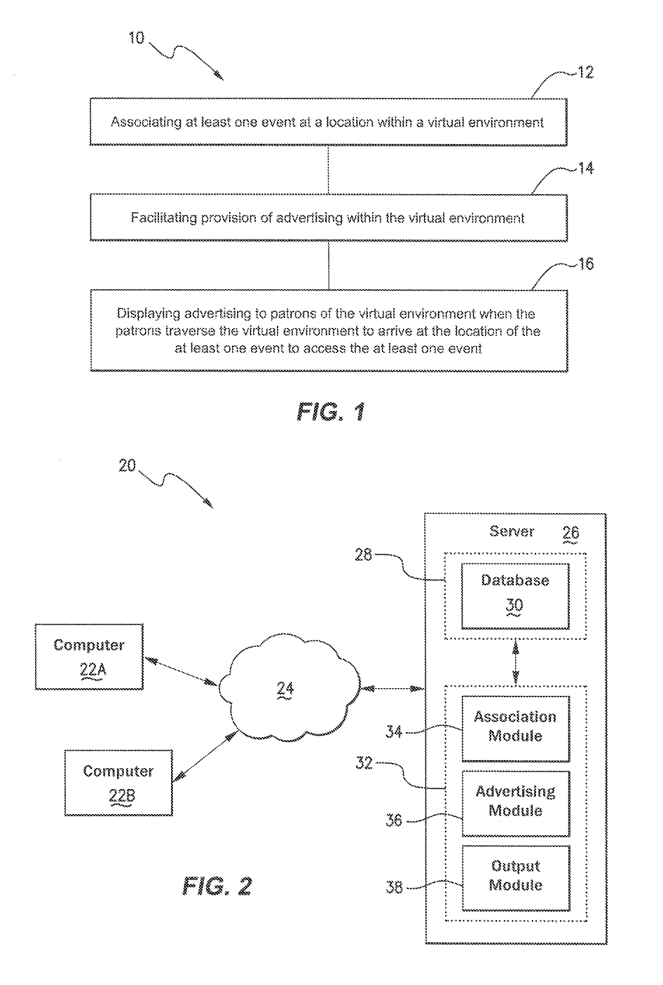

According to another embodiment of the present invention, there is provided a system 20 for implementing the method 10 as shown FIG. 2. The system 20 includes a plurality of remote computers 22A 22B accessing a server 26 via the Internet 24 to view (i.e. access) an event located in a virtual environment that is provided by the server. It will be appreciated by those skilled in the art that the system 20 may be used with respect to other networks, such as a LAN. In the embodiment, the server 26 includes a memory 28, storing a database 30 thereon to provide the virtual environment, and a processor 32, including a number of modules adapted to implement the system as described. In another embodiment (not shown), the memory is remote from the server 26 and may be accessed by the server 26 via the Internet 24. In this embodiment, the remote memory could be used to store data relating to advertising and a plurality of events for output to patrons of the virtual environment using the remote computers 22A 22B. Furthermore, the remote memory may reside on one or more remote servers.

The processor 32 includes an association module 34 for associating the event at a location within the virtual environment. As described, the event may be one of a plurality of pre-recorded games located at distinct locations within a virtual stadium. In this example, data indicative of a pre-recorded game is associated with data indicative of a corresponding location in the virtual stadium on the database 30 so that the required game can be accessed by a patron using a remote computer 22A.

The processor 32 also includes an advertising module 36 for facilitating provision of advertising within the virtual environment. In the example, the advertising module 36 is arranged to display selected advertising to patrons of the virtual stadium traversing the virtual stadium to arrive at the location of the associated pre-recorded game to access the pre-recorded game. For example, a patron traversing through the virtual stadium using his/her remote computer 22A to arrive at the location of a pre-recoded game may view advertising located along the way in the form of virtual shops. In the example, the advertising module 36 communicates with the database 30 to selectively retrieve advertising to be displayed at different locations in the virtual stadium to a patron.

In addition, the processor 32 includes an output module 38 arranged to output the event to patrons of the virtual environment when the patrons arrive at the location of the event in the virtual environment. In the example, the output module 38 receives instruction that a patron using his/her remote computer 22A has arrived at a location to access a pre-recorded game event and consequently outputs the pre-recorded game in the form of video to be viewed by the patron on his/her remote computer 22A. As described above, data relating to these events may be stored in a remote memory. In this case, the output module 38 is arranged to retrieve corresponding event data over the Internet 24 to output the event to patrons based on the location of the event in the virtual environment, as associated by association module 34.

In one example, the server 26 provides a virtual environment in the form of a virtual stadium to provide an event (e.g. content), traffic, shopping and sponsorship management system for sport on the Internet. The virtual stadium includes a virtual space within which events (in the form of content), traffic, advertising and sponsorship, etc. can be brought together. In addition, the association module 34 residing on the server 26 facilitates content creation and harvesting mechanisms to automatically or manually allow content owners (e.g. virtual stadium users/patrons) to place content (e.g. ladders, fixtures, pre-recorded games, etc.) in the virtual stadium, and facilitates content creation mechanisms to allow patrons to create and/or mark-up content associated in the virtual stadium. For example, the server 26 provides a virtual stadium for a basketball league within a virtual space where all content from the league might be placed, such as: statistics, ladders, playing dates, histories, live video, video library, interviews, training content, coach commentaries, etc. This content might be added to by patrons (e.g. viewers) of the virtual stadium including by interactions with other patrons. Furthermore, the advertising module 36 includes a sponsor or shop generation engine to generate advertising in the form of virtual shops and sponsorship to patrons (particularly for shops or sponsors whose owners have paid to access patrons). It is to be appreciated by those persons skilled in the art that the shops and sponsorship displayed to the patrons may vary according to each patron's profile and/or login details (if required by the system) and or the event being watched. Also, the advertisers and sponsors may pay to access a sub-set of the patrons for targeted advertising to these patrons.

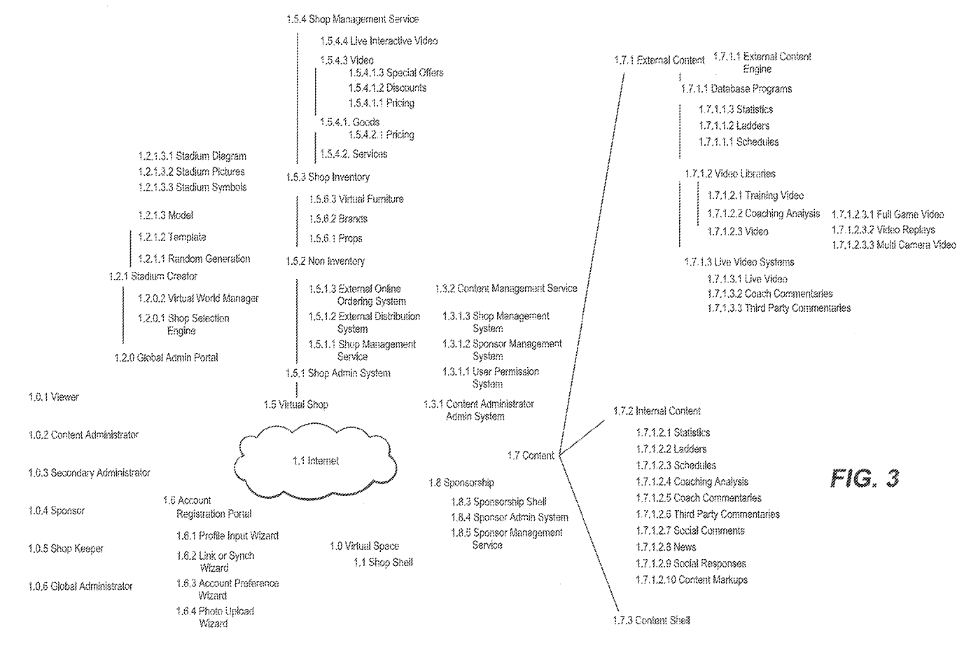

Referring to FIG. 3, one embodiment of the present invention includes a virtual environment including at least one Virtual Space 1.0 such as at least one virtual stadium. It will be appreciated by those persons skilled in the art that the virtual environment includes one or more Virtual Spaces 1.0 or virtual worlds.

The Virtual Space 1.0 includes a plurality of locations where events, in the form of Content 1.7, are associated and provided for output to patrons, in the form of content Viewers 1.0.1, to access. The Virtual Space 1.0 also includes advertising displayed to the Viewers 1.0.1 in the form of Virtual Shops 1.5 and Sponsorship 1.8, which is displayed to the Viewers 1.0.1 as they traverse the Virtual Space 1.0. In the embodiment, the Shops 1.5 are initially setup by a Global Administrator 1.0.6, which, in turn, is maintained by a Content Administrator 1.0.2. In addition, the Shops 1.5 can be managed by a Shop Keeper 1.0.5.

It will be appreciated by those persons skilled in the art that these administrative functions (Global Administrator 1.0.6, Content Administrator 1.0.2 and Shop Keeper 1.0.5) are provided by the advertising module 36 of FIG. 2, which facilitates provision of advertising in the Virtual Space 1.0, and the association module 34 of FIG. 2 which associates Content 1.7 in the Virtual Space 1.0. In addition, the Content 1.7 can be managed through an appropriate Content Administrator Admin System 1.3.1 (where the Content Administrator is given reasonable tools and access to control Content 1.7 across one or more Virtual Spaces 1.0) or a Content Management

Service 1.3.2 (where any reasonably permitted and skilled individual that is not the Content Administrator 1.0.2 can manage the Content 1.7 using a suitable control interface). In addition, the Content Administrator 1.0.2 can manage Content 1.7 across multiple Virtual Spaces 1.0 if provided.

Furthermore, the Virtual Space 1.0 might be attached to External Data Sources (e.g. an external database), where data is sourced from either directly or indirectly. These External Data Sources may include data pertaining to but not limited to events in the form of Content 1.7 such as: Database Programs 1.7.1.1, Video Libraries 1.7.1.2, and Live Video Systems 1.7.1.3. Also, it is to be appreciated that Internal Content 1.7.2 can be created in the Virtual Space by the Viewers 1.0.1. In this case, the Internal Content 1.7.2 is created inside the Virtual Space 1.0 using administrative portals. The administrative portals include a Global Admin Portal 1.2.0 and the Content Administrator Admin System 1.3.1, which can be used to create Content 1.7 such as: Commentaries 1.7.2.5, Social Comments 1.7.2.7, Coaching Analysis 1.7.2.4, Social Responses 1.7.2.7, and News 1.7.2.8. In one example, the Content 1.7 is placed, created or edited by an administrator using the Global Admin Portal 1.2.0 and or the Content Administrator Admin System 1.3.1 as shown in the flow chart of FIG. 6.

As described, the association module 34 associates events in the form of Content 1.7 at different locations in the Virtual Space 1.0. This Content 1.7 can be positioned in the Virtual Space 1.0 by the Content Administrator Admin System 1.3.1, Global Admin Portal 1.2.0 using a web-page or a Virtual Space construct. In addition, the Content 1.7 might also be optionally interactive, such that the interactive content might be dynamically operated on by the Viewer 1.0.1, or any other person. In this case, the Viewer 1.0.1 can call up a web page to change the Content 1.7. For example, the Viewer 1.0.1 can bring up a different Video 1.7.1.2.3 or change cameras for a particular video. Furthermore, the Virtual Space 1.0 might allow Content 1.7 to be maintained by the Viewer 1.0.1, such as News 1.7.2.8 which is updated by the Viewer 1.0.1.

In an embodiment, the Content 1.7 includes, but is not be limited to, events occurring in a sporting game such as Live Video 1.7.1.3, and pre-recorded Video 1.7.1.1.1 (e.g. video of sporting games or training sessions), Full Game Video 1.7.1.2.3.1, Video Replays 1.7.1.2.3.2, and Multi Camera Video 1.7.1.2.3.3 (where multiple videos might be available of the same game and the Viewer 1.0.1 can tab between camera views). Also, the Content 1.7 includes other information including Ladders 1.7.1.1.2, Schedules 1.7.1.1.1, Statistics 1.7.1.1.3, Social Comments 1.7.2.7, or any other content which might reasonably be required and or enjoyed by participants of the sporting game. For example, the Viewer 1.0.1 can traverse the Virtual Space 1.0 using a remote computer 22A to arrive at the location of the Live Video 1.7.1.3 of a particular sporting game in the Virtual Space 1.0. The output module 38 then outputs the desired Live Video 1.7.1.3 to the Viewer 1.0.1 in a format suitable to be played by the remote computer 22A for viewing by the Viewer 1.0.1 (e.g. streaming video). Furthermore, in another embodiment, the Content 1.7 can be generated for associating by the association module 34 at locations within the Virtual Space 1.0 according to an event movie recording and playback system and method described in U.S. provisional application 61/310837 and described in detail below.

In an embodiment, the Virtual Space 1.0 provides Virtual Shops 1.5, where a shop is any precursor to purchasing goods and services in the Virtual Space 1.0. In this embodiment, the advertising module 36 shown in FIG. 2 facilitates provision of advertising in the form of these Shops 1.5. The advertising module 34 also allows a Shop Keeper 1.0.5 to have reasonable control over the delivery of goods and services 1.5.3 through an appropriate Shop Admin System 1.5.1 or through a Shop Management Service 1.5.4 run by any reasonably authorized person to manage the Shop 1.5 using any suitable control interface. It is envisaged that such a control interface may be used by the Shop Keeper 1.0.5 to manage more than one Shop 1.5 in one or more Virtual Space 1.0.

In an embodiment, the Shop 1.5 in the Virtual Space 1.0 provides for the attachment of External Data Systems to facilitate the distribution and or payment of goods and services advertised within the Virtual Space 1.0. These external data systems include an External Distribution System 1.5.1.2 and an Online Order System 1.5.1.3. Furthermore, the attachment might take the form of automation between one system and another and may be implemented by a Shop Management Service 1.5.4 to produce the effect of the Viewers 1.0.1 being able to buy goods. In this case, the Viewers 1.0.1 can buy goods by placing an order in the Virtual Space 1.0, which is sent out of the Virtual Space 1.0 to one of these external systems to be actioned (e.g. to securely withdraw money from a Viewer's 1.0.1 entered account details)

In an embodiment, the Shop 1.5 in the Virtual Space 1.0 provides an Inventory 1.5.5 including goods and or services to be sold to the Viewer 1.0.1. These goods and services include Goods 1.5.4.1, Services 1.5.4.2, Video 1.5.4.3 in any form or format, Live Interactive Video 1.5.4.4, particularly Live Service Deliveries (e.g. video conference systems either as a video stream or a virtualization), and any other Inventory 1.5.5 which might be regarded as having a commercial value. In this embodiment, the Inventory 1.5.5 is controllable within the Shop Admin System 1.5.1 or through the Shop Management Service 1.5.4. Furthermore, the Shop 1.5 in the Virtual Space 1.0 provides for Non-Inventory 1.5.6 items to be placed within the Shop 1.5, including Props 1.5.6.1, Brands 1.5.6.2, Virtual Furniture 1.5.6.3, or any other item which might be regarded as non-saleable, such as goods with a practical, decorative, or communicative purpose. Furthermore, the Viewer 1.0.1 is able to browse the Inventory 1.5 to “try on” inventory, buy inventory, mark up inventory, and/or create inventory items.

Furthermore, the Shop Admin System 1.5.1 or the Shop Management Service 1.5.4 provides for the pricing of the Inventory 1.5.5 in each Shop 1.5 to be controlled. For example, the pricing 1.5.4.1.1 of Goods 1.5.4.1, special pricing to particular Viewer 1.0.1 groups or within particular Virtual Spaces 1.0, Discounts 1.5.4.1.2, and Special Offers 1.5.4.1.3 can be controlled. Also, the Shop 1.5 in the Virtual Space 1.0 may be configured to be displayed only to designated Viewers 1.0.1. For example, the Shop 1.5 may be displayed to Viewers 1.0.1 of designated gender, age bracket, etc. In addition, the Virtual Space 1.0 may include zones allocated to these designated Viewer Classes. In one embodiment, Viewers 1.0.1 pre-register and the registered information is used to group Viewers into classes using the Shop Admin System 1.5.1 the Shop Management Service 1.5.4 for targeted display of Shops 1.5, as shown in FIG. 8.

FIG. 8 shows a flow chart of an example of a Viewer 1.0.1 entering and traversing the Virtual Space 1.0 to view events and consequently advertising. In the example, the Viewer 1.0.1 registers 6.1 using an account registration portal which stores the Viewer 1.0.1 entered details in an external data source. For example, the registration includes registration performed by the Global Administrator 1.0.6 using a registration interface 1.6 relating to one or multiple Virtual Spaces 1.0. The registration process creates a unique user login for the Viewer 1.0.1 as a means of entering the Virtual Space 1.0 and as a unique identifier which can interact with the Shops 1.5, Content 1.7, and Sponsorship 1.8. In this manner, the Content 1.7, and the efficacy of advertising in the form of Shops 1.5 and Sponsorship 1.8 is enhanced through preferential or selective presentation of material according to Viewer's registered details. The Viewer 1.0.1 then logs 6.2 into the Virtual Space 1.0 using the unique login, in the form of a virtual world, and advertising in the form of virtual shops is displayed to the Viewer 1.0.1 as he/she traverses 6.3 6.4 through the virtual world. As described, the shops are displayed based on the Viewer 1.0.1 inputted registration details such as age, sex, etc. The Viewer 1.0.1 may then arrive at a location in the virtual world to view 6.5 6.6 internal and external content and may edit 6.7 some of the content to generate further internal content to be viewed by subsequent Viewers 1.0.1. These Viewers 1.0.1 can also socialise 6.8 between themselves, such as chat, and enter 6.10 one or more of the virtual shops displayed in the virtual world to purchase goods.

In another embodiment, the Shop 1.5 is located within and thus connected to a number of Virtual Spaces 1.0, where that connection allows the Viewer 1.0.1 to move from the Virtual Space 1.0 to another, or stay within the Virtual Space 1.0. This is achieved even where multiples of other Viewers 1.0.1 in other Virtual Spaces 1.0 might be looking at that same Shop 1.5 in their respective Virtual Space 1.0. Thus, in this case, if one of the Viewers traverses the Virtual Space 1.0 into the Shop 1.5 in one Virtual Space, it might be regarded as a separate Virtual Space within the Virtual Space for the other Viewers. This Shop 1.5 is mirrored, copied, linked, or duplicated so that it can exist in multiple Virtual Spaces but function as a single Shop 1.5.

The Shop 1.5 might be placed, like a physical shop, as a static object within the Virtual Space 1.0, or as a region within the Virtual Space as a Shop Shell 1.5.6. For example, a Shop 1.5 may resides in the Shop Shell 1.5.6 and the particular shop displayed in the Shop Shell 1.5.6 might change dynamically according to a variable including the Viewer 1.0.1 registered profile. It will be appreciated by those persons skilled in the art that the Shops 1.5 might otherwise be deposited randomly within the Virtual Space 1.0. Also, the layout of the Shop 1.5 can be controlled, including controlling the layout and placement of inventory (e.g. saleable goods and services) and non-inventory, (e.g. Props 1.5.6.1, Brands 1.5.6.2, Brand Relatable, Virtual Furniture 1.5.6.3, information in any reasonable form including two way Video or communication with a Shop Keeper or any other individual). In addition, the size and template layout of the Shop 1.5 is selectable and controllable within the Shop Admin System 1.5.1, or through the Shop Management Service 1.5.4.

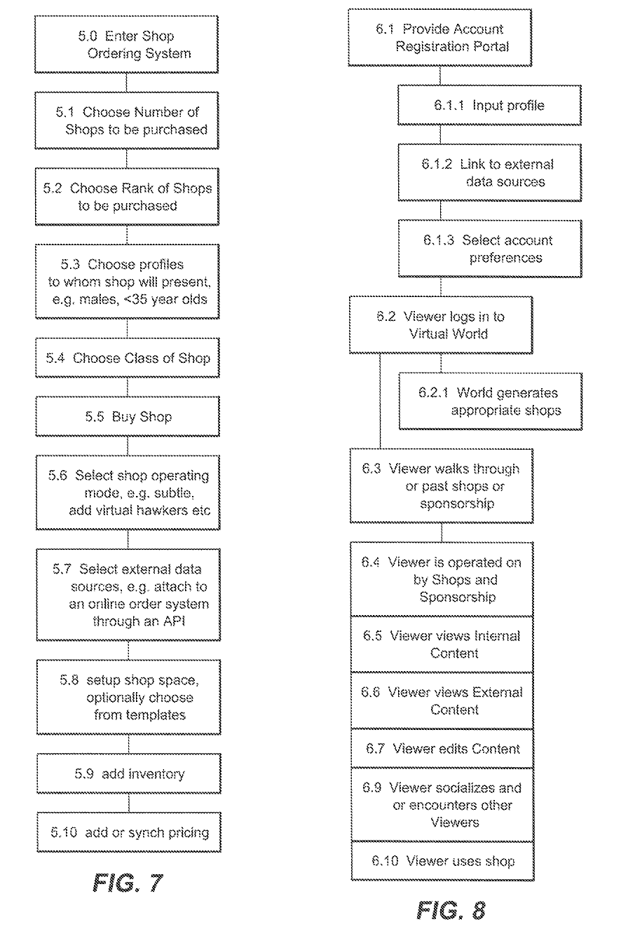

In an embodiment, the mode of the Shop (e.g. how the Shop interacts with the Viewer 1.0.1, such as signs, audio, props, or any other media, and any other peripherals can be changed by the Shop Keeper 1.0.5 and the Global Administrator 1.0.6. FIG. 7 shows a flow chart of an example of the Shop Keeper 1.0.5 configuring a Shop 1.5 to display advertising to Viewers 1.0.1 of the Virtual Space 1.0. In the example, the Shop Keeper 1.0.5 enters 5.0 a virtual shop ordering system and selects 5.1 to purchase a number of shops (e.g. purchasing advertising space in the Virtual Space 1.0). The Shop Keeper 1.0.5 can then rank 5.2 the shops purchased according to prominence of display and select 5.3 a profile of Viewers 1.0.1 which the shops will be substantially displayed to based on Viewer registered details. The example further includes provision for the Shop Keeper 1.0.5 to choose 5.4 a class of shop, buy 5.5 the shop, select 5.6 an operating mode, and select 5.6 external data sources to host shop data. In addition, the example includes selecting 5.8 templates of shops, and allowing the Shop Keeper 1.0.5 to add 5.9 Inventory 1.5.3 to be sold at the shop and set 5.10 pricing of the Inventory 1.5.3.

In another embodiment, advertising in the Virtual Space 1.0 is provided in the form of Sponsorship 1.8. In this case, a Sponsor 1.0.4 might be provided with control over Sponsorship 1.8 in the Virtual Space 1.0 through an appropriate Sponsor Admin System 1.8.4, or a Sponsor Management Service 1.8.5. Also, the Sponsorship 1.8 includes sending a message to the Viewer 1.0.1 including an Image 1.8.6.1, Video 1.8.6.2, Prop 1.8.6.3, or any other form of sponsorship or advertising which might be interactive or non-interactive. The Sponsorship 1.8 is managed within the Virtual Space 1.0 using the administrative portals described above and multiple Sponsorship Types 1.8.6 can be managed. This management includes positioning the Sponsorship 1.8 in the Virtual Space 1.0, selecting the type of Sponsorship 1.8 to be displayed, tracking the Viewers 1.0.1 of the Sponsorship 1.8, controlling the operating mode of the Sponsorship 1.8, and controlling display of the Sponsorship 1.8 in the same manner as for the Shops 1.5 described above.

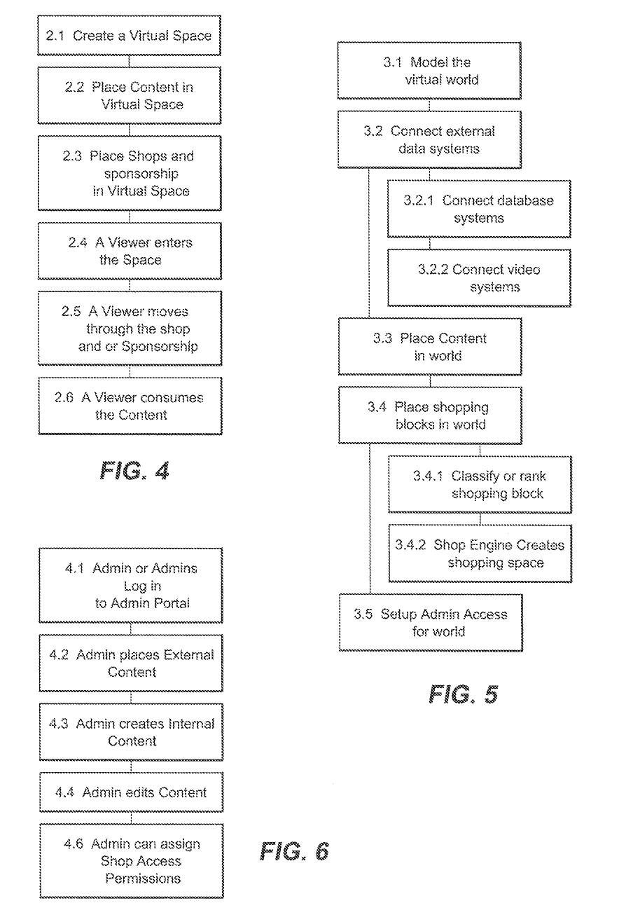

Referring now to FIG. 4, there is shown an example of a method of advertising in a virtual environment implementing the embodiment shown in FIG. 3. The method shown in FIG. 4 includes the steps of creating 2.1 a Virtual Space 1.0, placing 2.2 Content 1.7 in the Virtual Space 1.0, placing 2.3 Shops 1.5 and Sponsorship 1.8 in the Virtual Space, at least one Viewer 1.0.1 entering 2.4 the Virtual Space, and the Viewers moving 2.5 though the Virtual space 1.0 and viewing displayed Shops 1.5 and or Sponsorship 2.5. The method further includes the Viewer 1.0.1 consuming 2.6 the Content 1.7 (e.g. accessing the content). In this example, the Viewer 1.0.1 can purchase Inventory 1.5.3, consume Non-Inventory 1.5.2 from the Shops 1.5 and consume the Sponsorship 1.8.

As above, the setup of a Virtual Space 1.0 shown in FIG. 3 can be performed by the Global Administrator 1.0.6 using an appropriate Setup Wizard 1.2.1 or tool. In addition, the Virtual Space 1.0 might be generated using Random Generation 1.2.1.1, by Template 1.2.1.2 or using a Real World Model 1.2.1.3 so as to create an appropriate Virtual Space 1.0 for the Content Administrator 1.0.2 to display and monetize Content 1.7 to be accessed by Viewers. In an example, the Virtual Space 1.0 is modelled on a sporting team home stadium for a particular sporting team using an appropriate Stadium Diagram 1.2.1.3.1, or a practical equivalent, using Stadium Pictures 1.2.1.3.2 and Stadium Symbols 1.2.1.3.3 as model textures to reflect a real stadium. The virtual stadium may also include additional objects not found in the real stadium to assist navigation including signs, arrows, rooms and the like.

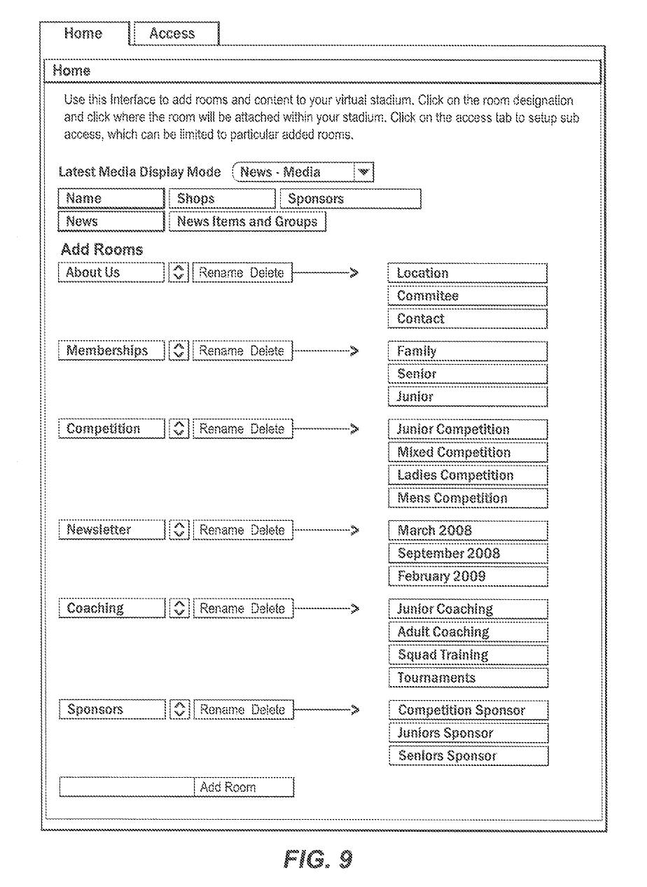

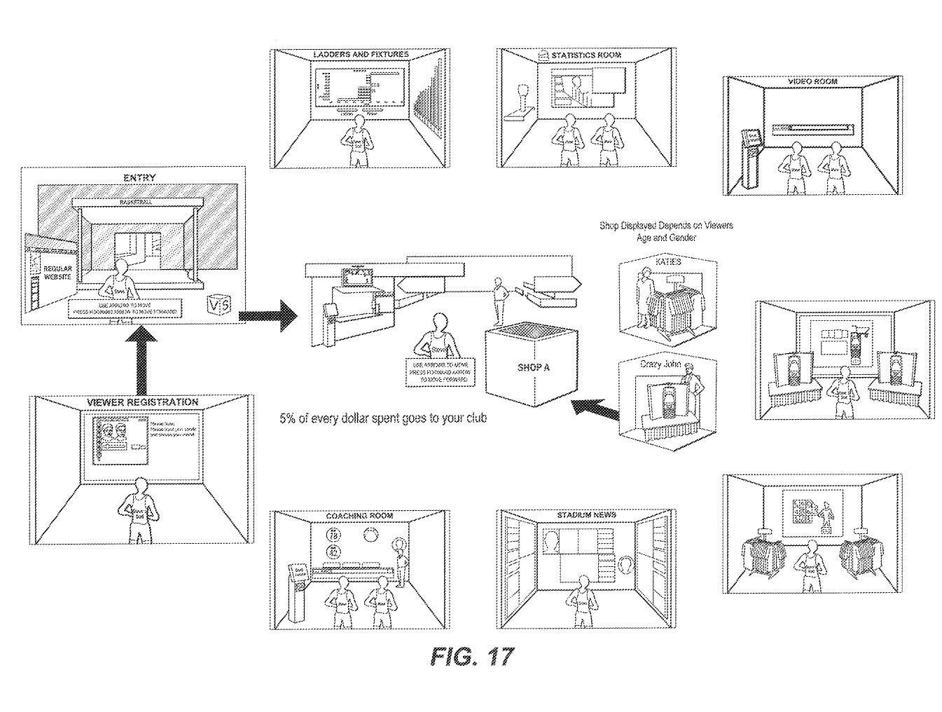

FIG. 5 shows an example of a method of placing Content 1.7 (i.e. associating events) and placing shopping blocks (i.e. placing advertising) in a virtual environment in the form of a virtual world for Viewers 1.0.1. The method including initially modelling 3.1 the virtual world (e.g. modelling the virtual world on a real stadium), and connecting 3.2 external data systems to host the Content 1.7. This Content 1.7 is connected to the virtual world through an appropriate engine 1.7.1.1 and examples of sources of external content include: Database Programs 1.7.1.1, Video Libraries 1.7.1.2, Live Video Systems 1.7.1.3, or any other program or system that might act as a repository or source of Content 1.7. The method also includes placing 3.3 the Content 1.7 in the virtual world so that a Viewer 1.0.1 can view Content 1.7 including: Sporting Statistics 1.7.1.1.3, Sporting Ladders 1.7.1.1.2, Sporting Schedules 1.7.1.1.1 Game Video 1.7.1.2.3, Coaching Analysis 1.7.1.2.2, Training Video 1.7.1.2.1, Live Video 1.7.1.3.1 Coach Commentaries 1.7.1.3.2 Third Party Commentaries 1.7.1.3.3 or any other content from Database 1.7.1.1, Video Library 1.7.1.2 or Live Video and Markup 1.7.1.3. The Content 1.7 might also be created by the Viewers 1.0.1, i.e. Internal Content 1.7.2, during setup 3.3, using an appropriate interface, such as the Global Admin Portal 1.2.0, Stadium Creator 1.2.1, or the Content Administrator Admin System 1.3.1, as depicted in FIG. 9 and FIG. 17. The position of Content 1.7 in the Virtual Space 1.0 can also be assigned statically, (e.g. during the setup of the Virtual Space 1.0), or it can be positioned such that a region of the Virtual Space 1.0 is assigned to display a defined piece of Content 1.7 (e.g. Sporting Ladders 1.7.1.1.2 or Sporting Schedules 1.7.1.1.1) to allow Viewer interaction with the Content 1.7. Alternatively, the Content 1.7 can be positioned after the Virtual Space 1.0 is setup. For example, the Content 1.7 can be assigned dynamically by the Administrator after Virtual Space Setup, or might be assigned dynamically by the Viewer 1.0.1 during consumption or interaction with the Content 1.7, as depicted in FIG. 6. Also, the Content 1.7 can be assigned by a Content Management Service 1.3.2 to position Content 1.7 within a Virtual Space 1.0.

The method shown in FIG. 5 further includes the steps of placing 3.4 shopping blocks in the virtual world, classifying 3.4.1 the shopping blocks and thus creating 3.4.2 a shopping space. For example, a particular Shop 1.5 or a Shop Shell 1.5.6 might be positioned during the setup of the Virtual Space 1.0 and ranked according to its relevance to a particular Viewer 1.0.1 to allow for the dynamic placement of the Shop 1.5. In addition, the method includes setting 3.5 up administrator access so that an administrator can edit the position of Shops 1.5 or Sponsorship 1.8 in the Virtual Space 1.0. Furthermore, the position of Shops 1.5 or sponsorship 1.8 might be ranked or tiered 3.4.1 according to the distance from traffic flows in the virtual world, or some other reasonable variable. Furthermore, access 3.4 to the shop's content (e.g. inventory) can be turned over to the administrator 1.0.2 and or the Shop Keeper 1.0.5 for the ongoing maintenance of the shop's content.

An example of a virtual stadium is given with reference to the exemplary screen shots of FIGS. 9 to 17.

In the example, the virtual stadium representing a real stadium hosting sporting games, such as basketball games, is created, and administrators of these games can access the virtual stadium to add events (e.g. content) to be viewed in rooms located within the virtual environment, as shown in FIG. 9. For example, administrators can login to the virtual stadium and add locations in the virtual stadium corresponding to different competitions hosted by the real stadium (e.g. Junior, Mixed,

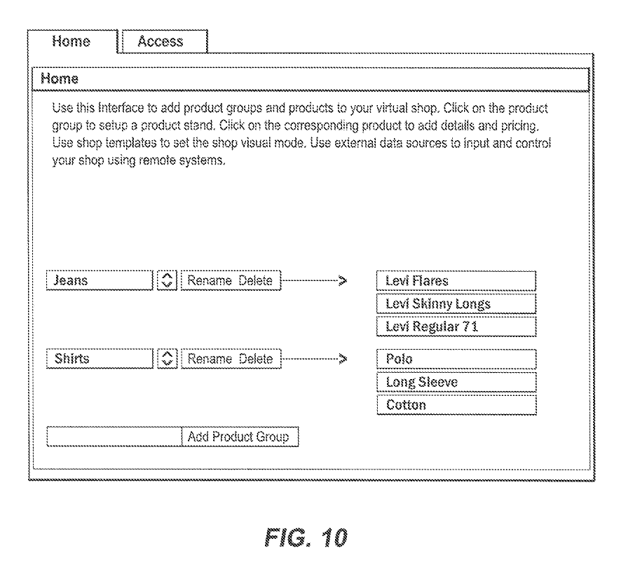

Ladies', and Men's Basketball Competitions). The administrators can then associate events (content) in these locations to be viewed by patrons of the virtual stadium. In addition, advertisers may wish to advertise goods and/or services to the patrons of the virtual stadium wishing to view the content, and the advertisers can set up virtual shops within the virtual stadium as shown in FIG. 10. For example, an advertiser may wish to sell jeans to patrons of the virtual stadium and can virtually represent these jeans in a virtual shop to be viewed by the patrons traversing the virtual stadium and potentially be purchased.

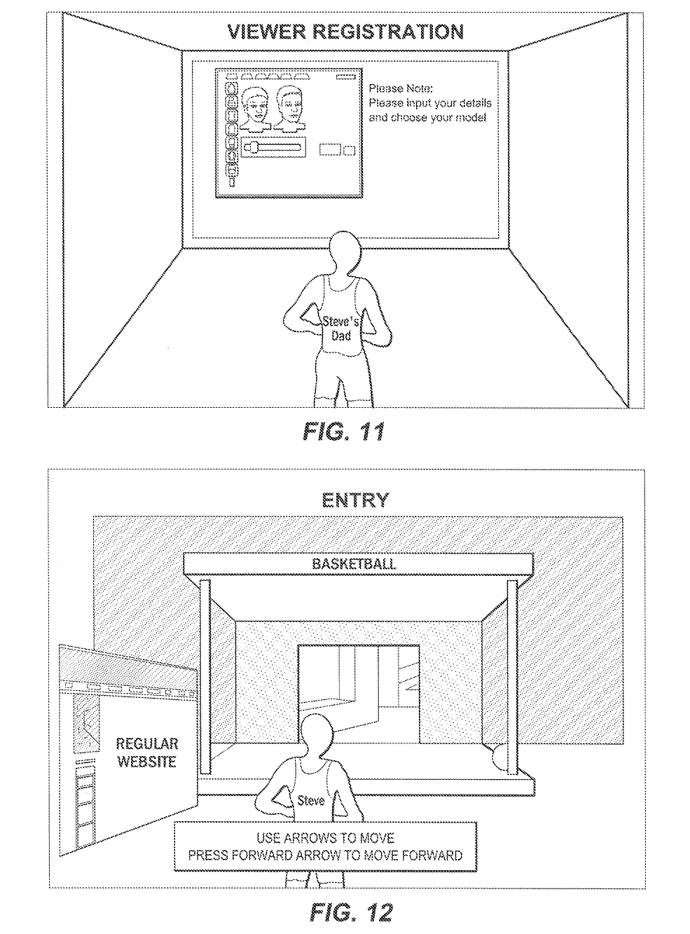

Furthermore, patrons (viewers) can register details to better target advertising to them and or the provision of content. A viewer registering details (e.g. age, sex, competition of interest, etc.) is shown in FIG. 11. In an example, the virtual stadium may host multiple games (e.g. basketball, indoor soccer, badminton, etc) for multiple competition categories. In the example, the viewer selects to enter the basket portion of the virtual stadium in FIG. 12. It is envisaged however that different virtual stadiums could be implemented for the different games, e.g. a dedicated virtual stadium for basketball and a dedicated virtual stadium for indoor soccer. It can also be seen from FIG. 12 that the viewer may access the virtual stadium from a web page, and that the virtual stadium is a three dimensional representation of a real stadium and the viewer has a three dimensional avatar to traverse the virtual stadium.

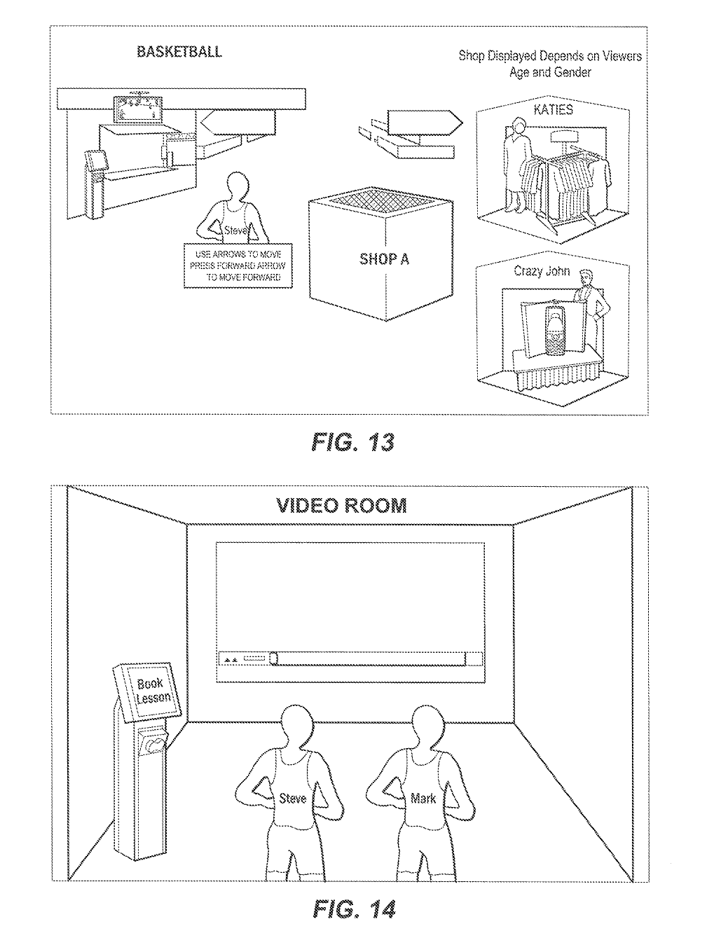

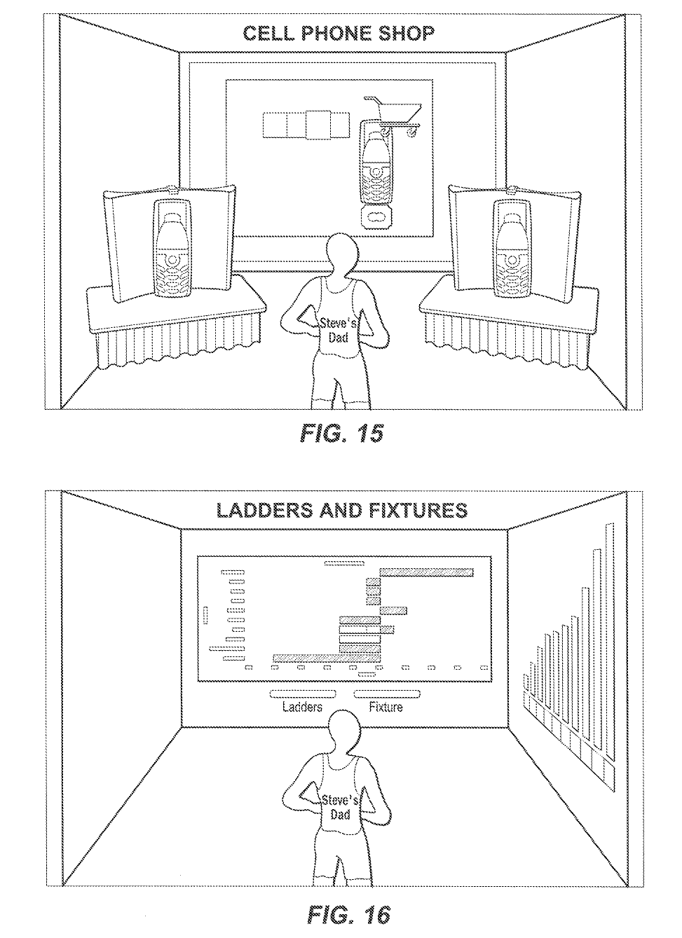

In the example, the viewer traverses the virtual stadium and has advertising displayed to him/her in the form of a Shop A, as shown in FIG. 13. The Shop A is a shop shell as described above so that the shop displayed to the viewer is dependent on the details of the viewer, such as age and gender. In one example, the viewer is interested in mobile phones and a mobile phone store is displayed to the viewer, as shown in FIG. 15. After viewing the advertising, the viewer then further traverses the virtual stadium to arrive at a video room to view a pre-recorded video of a basketball game, as shown in FIG. 14. The pre-recorded video is then outputted to the viewer in the form of video. It can be seen in this Figure that more than one viewer can view the pre-recorded video at the same time in the virtual stadium. In addition, the viewer can then traverse the virtual stadium to arrive at another room where ladders and fixtures of a basketball game are outputted for display to the viewer as shown in FIG. 16.

FIG. 17 shows a summary of the above example where the viewer first registers details and then enters a virtual stadium. Here it can be seen that the viewer traverses the virtual stadium, represented in three dimensions, to arrive a location of content relating to a basketball game hosted by the virtual stadium to access the content, and has advertising in the form of virtual shops displayed to him/her along the way. In addition, FIG. 17 shows additional rooms containing statistics, coaching information, and stadium news accessible by the viewer traversing the halls of the virtual stadium.

By way of a further example of the above described method and system for advertising, reference will be made to the US provisional application 61/310837, the content of which will be incorporated herein.

In this further example, the above described events to be associated at respective locations within the virtual environment are to be recorded from a real stadium and played back to patrons of the virtual stadium using the event movie recording and playback system and method described in U.S. provisional application 61/310837. In this example, the association module 34, as shown in FIG. 2, is further arranged to associate events recorded using this event movie recording and playback system at locations within the virtual stadium for subsequent outputting to patrons. That is, in this example, the system for advertising also includes the capability to record events to be associated at locations in the virtual environment for subsequent output and playback using the below described system.

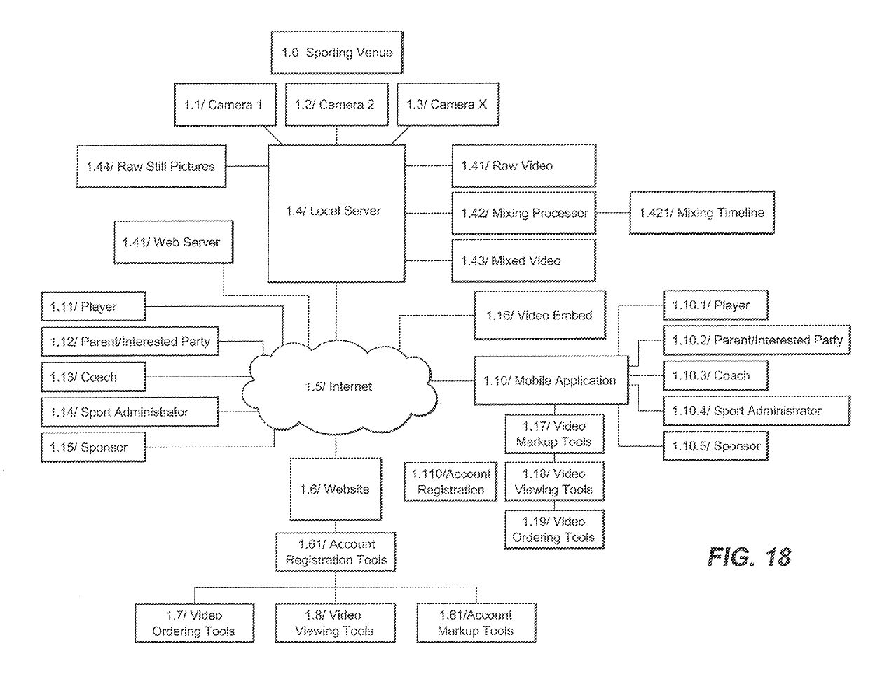

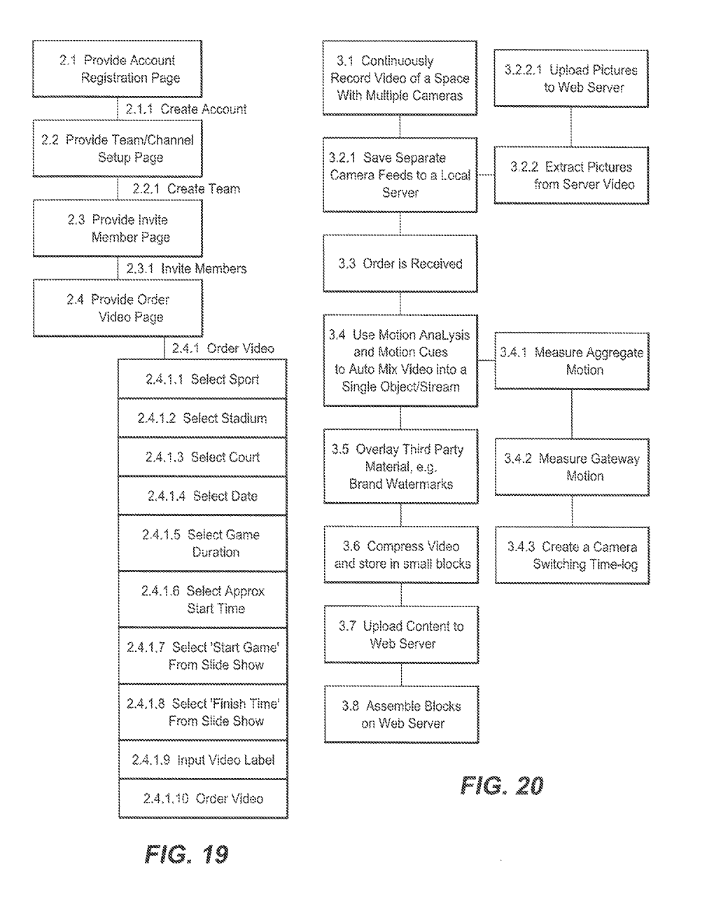

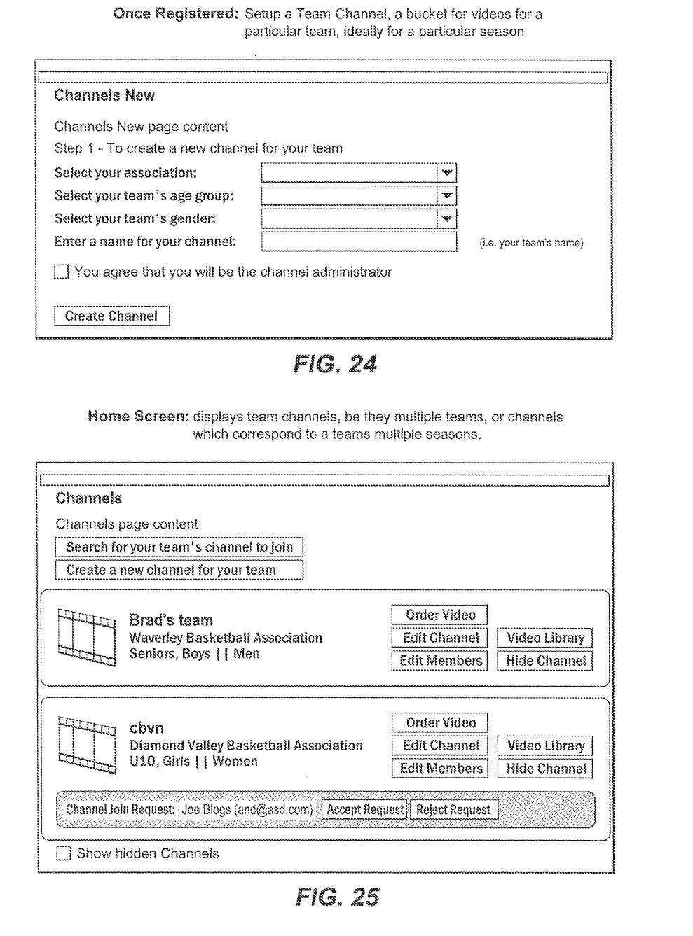

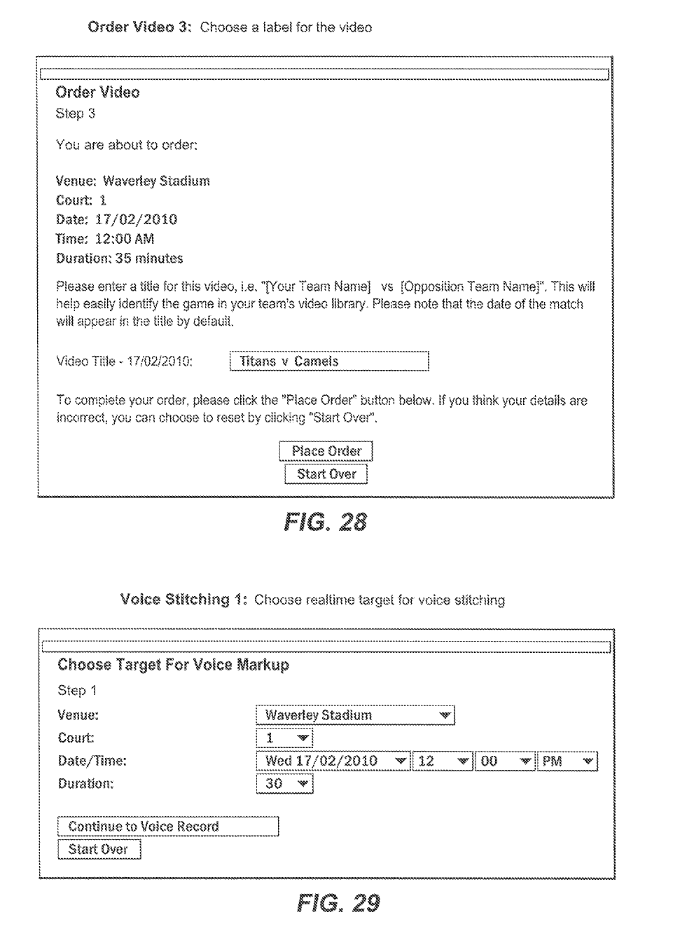

Referring now to FIGS. 18 to 33, there is shown an example of an event movie recording and playback system and method for use with the embodiment. In the example, the event movie recording and playback system comprises at least one movie camera for obtaining moving picture images of multiple sequential events, a continuous recording system connected with a computer server for recording moving picture image signals obtained from the at least one movie camera of the multiple sequential events and for assigning time marker signals from which a playback start and finish time for individual events can be chosen, the computer server being connected with a network to which members of the public have access via remote computer devices, and wherein when a member of the public requires to view an individual event as a movie playback the member is required to access the computer server via the network from a remote computer device and to invoke an ordering process for the individual event which is defined by recorded start and finish time marker signals, and wherein a video player is invokable at the remote computer device so that when the individual event has been ordered the moving picture image signals of the individual event can be downloaded over the network and viewed on the video player.

In one example, video utilization within non-elite sporting communities is limited. A combination of finances, expertise, privacy concerns, high volunteer turn-over, an uncontrolled environment, limited volunteer hours, the sheer number of players, all contribute to the difficulty. For example videoing a particular amateur game might require the setup of a camera, or cameras, a willing and able camera person(s) to be identified and managed, a willing and able editor(s) to be identified and managed, some-one to distribute the game etc: ignoring entirely any further post production of video analysis to provide coaching or similar which might aid learning. Thus, any effort to broadcast or utilize video in amateur sport has been too expensive.

An embodiment solves the cost issue using three components. The first uses hard mounted fixed security video cameras, robust enough to tolerate the harsh environment of a not for profit sporting community, connected to a local video server, that are substantially always recording. This setup removes the burden of managing when and who will setup the camera(s), physically setting up the camera(s), setting up and having proper access to cabling and the like. Such arrangement is outlined in FIG. 18.

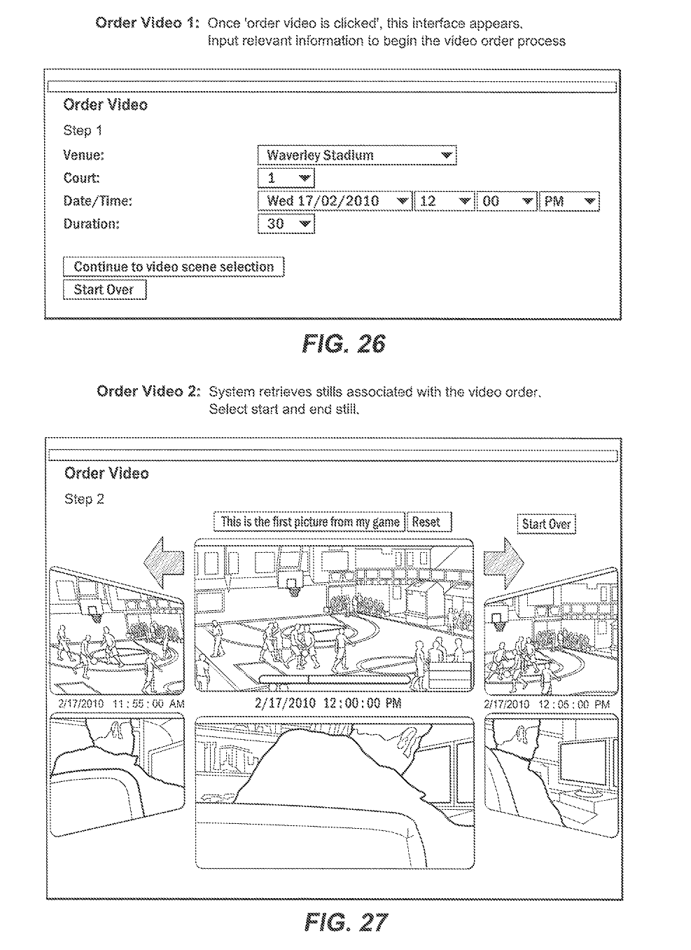

The second component uses software on a video server 1.4 to perform post recording aggregate motion analysis and point motion analysis of the recorded video, thereby allowing it to be mixed automatically, such that it ‘follows’ the play, without an editor. However this by itself does not create a video, which also needs a start and an end point, which cannot be computed automatically. However, non-elite sporting games do not always, or even often, start when they are intended, therefore top down or predefined start end points may cut some of the game. A specialized video ordering interface, depicted in FIGS. 26, 27 and 28, is used to extract accurate start and finish times for the video, and therefore provide sufficient information for end to end automation in the creation of video. This combination of techniques removes the need entirely for a camera person, for an editor, manager or administrator, and or for an individual to uplift the video content or distribute the content to interested parties. This process has been described in FIG. 20 and depicted in FIGS. 26, 27 and 28. The mixing process is part of this embodiment but may be omitted in other embodiments.

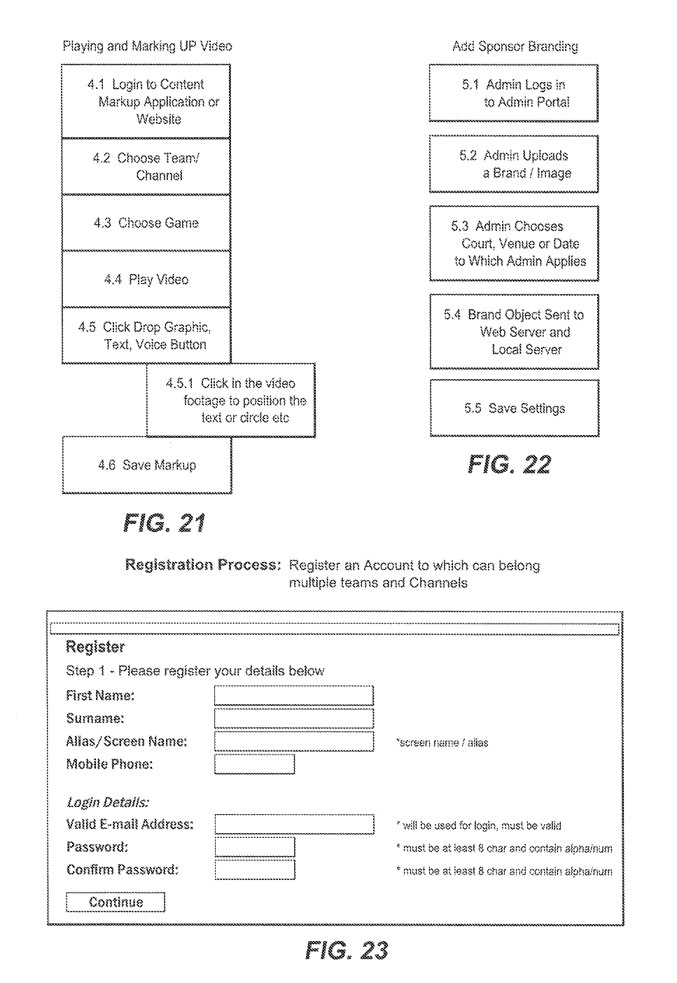

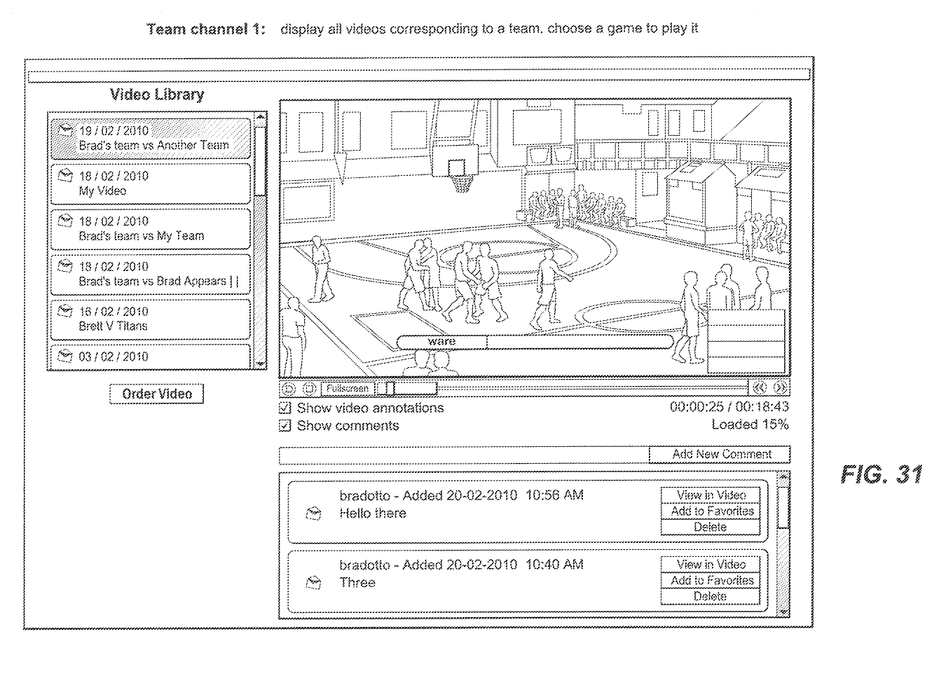

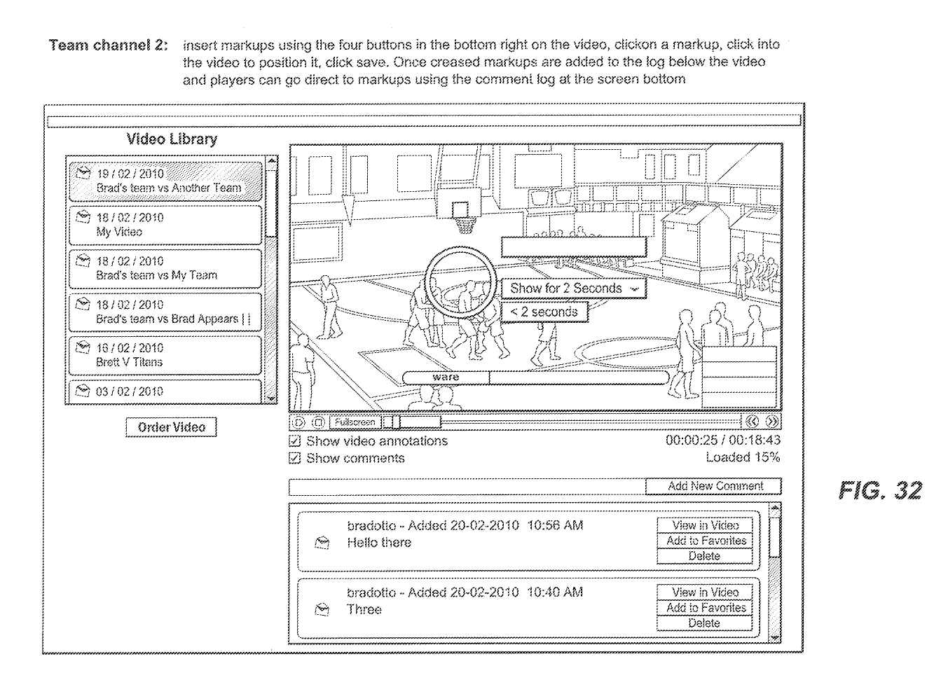

The third component uses a video player to play back video. The player, while including the normal controls, also includes single click tools to drop markers such as circles, comments and voice directly onto the video. This streamlines the process and removes the skill requirements, specialized software and time requirements normally associated with video editing. This process has been described in FIG. 21 and depicted in FIGS. 31 and 32.

Embodiments of the invention may have further features as follows:

Real Time Mark-Up:

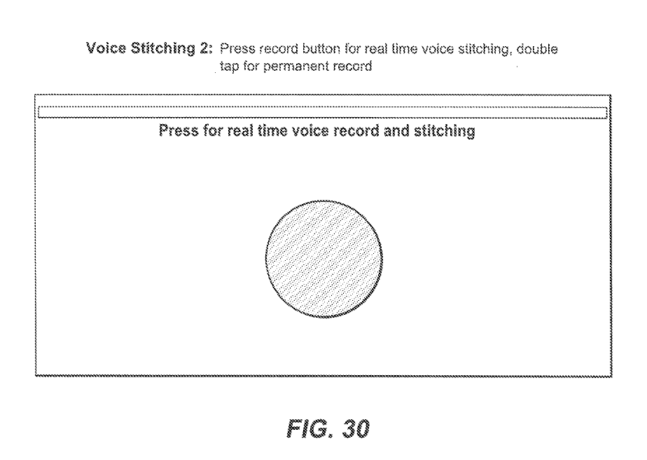

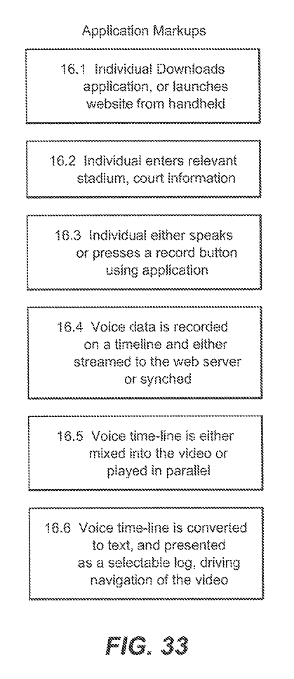

There are instances when an automated broadcast video with post game mark-up may be too expensive. For example a tennis coach using a preferred system, coaching several players in a particular session, would need to watch the video of a lesson and perform post-session mark-ups, obviously adding to the time and cost of tennis coaching. It is therefore possible to provide real time mechanisms for marking up video, for example but not limited to mixing in real time voice streams, by a suitable combination of hardware and data transfer, such that said tennis coach might speak during a lesson, and a student might subsequently watch a recorded video of the lesson and listen to the coach voice overlay. This process has been outlined in FIG. 33 and depicted in FIGS. 29 and 30.

Real-time mark-ups might take a number of forms, on a number of devices using a number of transfer techniques.

Sponsorship:

A problem also exists within non-elite communities relating to a stakeholder class outside the day to day activities of a non-for-profit sport community. Indeed not-for-profit and non-elite sporting communities are typically sponsored by businesses, whose participation in the community might be for profit, for public good or some combination. But, interacting with a non-for-profit sporting group is typically a high cost, low outcome, unmeasurable exercise, particularly because of high volunteer turn-over, lack of skills to deliver branding and offers to members, small and inaccurate databases and other factors which reduce the attractiveness of non-elite sporting communities for business. Indeed this is part of what separates “sponsors” from “advertisers”.

Techniques such as those described above or other techniques to add mark-up to games would create similar benefits for sponsor stakeholders, such that either a centralized or per stadium mechanism might place sponsorship and advertising into video to reduce the cost of reaching sport community members, increase the efficacy of branding or offers put to said community and increase the measurability of the exercise. This process has been broadly described in FIG. 22.

Thus, the combination of these technologies, particularly the recording technology, the optional motion mixing engine, custom ordering system and a unique video player and real time mark-up technology, produce, in one embodiment, an end to end delivery system which reduces the cost of the video delivery, and increases the potential for utilization by all members of the non-elite community, to the point where it is within the resources of non-for-profit sporting communities to utilize video. This is not to say no benefit exists for elite communities, indeed the tools would provide a substantial cost reduction in what might be being done, but the net-effect of this combination of technologies at the non-elite level is profound, to the extent it makes ‘broadcasting’ amateur sport viable, makes video analysing amateur sport viable and makes advertising participation in amateur sport viable. Thus an example of the system allows particular events such as a particular game to be recorded onto a transportable digital media device such as a DVD or memory stick or similar, and provides a source of potential income to the stakeholders by sales of such media devices.

The combination of these technologies also produce a number of concrete advantages, from producing inventory that the non-elite sport could sell to its members, either as pay-per-view web-streams, subscriptions, DVD's, or any other suitable video based transaction, a virtual bill-board on which to put sponsors, a training tool for coaches, a training tool for referees and umpires, an entertainment tool for players and parents, records for security and insurance etc.

Suitable installation locations for an automated broadcast system might include local basketball, netball, hockey, volleyball, indoor cricket stadiums, soccer fields or any other location with regular activity such as horse racing at horse racing events etc where the video of that activity is in demand, but for which it is currently too expensive to capture, edit and distribute.

A large basketball association might have 10,000 active players across 20 courts playing 40 games per year, which translates into roughly 200,000 player games. If games were being sold on a per game basis, through volunteer produced DVD's for example, the total inventory would be worth $8 million dollars. Include with this leveraged revenue opportunities, e.g. sponsorship and advertising, and in-direct revenue opportunities, increasing the number of players, and the revenue advantages alone are substantial, disregarding the before mentioned non-revenue based advantages.

The video cameras used either singularly or in multiples to capture footage of a particular field, venue or other suitable location, might take the form of any suitable and sufficiently robust video camera. Non-for-profit community environments are uncontrolled, often outdoors, and therefore any onsite hardware must be bullet proof, weather proof, modular and easily serviceable. Security cameras, in particular, provide an adequate technology being naturally designed to resist tampering or damage, weather, having well established mounting technologies and being nested within supply chains so as to reduce installation cost. New HD security video cameras provide both robustness and picture quality, shooting in the same resolution as cameras more often associated with ‘broadcasting’. However, any device, fixed or mobile, which captures video footage, might be used.

An onsite computer or box needs to communicate with one or more cameras through a suitable data transfer method, including but not limited to hard cabled networks, wireless networks or the like. The ‘server’, being a bundle of storage, processing and data transfer resources, might be installed as one online onsite box, multiple online onsite boxes, one offline onsite box which uses a suitable portable storage device, including but not limited to a portable hard drive or smart phone, to transfer data to an online offsite box. The particulars of the arrangement are immaterial provided data from one or more cameras is moving to a computing box, either directly or indirectly, where it can be mixed automatically post recording and distributed, either directly or indirectly through a web server, or through any other suitable data transfer method, including but not limited to direct transfer of data from a local box to smart phone.

The video mixing engine in one embodiment uses aggregate motion analysis (motion detection) and point triggers to create a video switching instruction set. Point motion triggers, may take the form of any technology, such as motion triggers placed over particular parts of a visual scene, a magnetic detector placed on a basketball ring, or any other suitable technique or technology which can automatically read out an event in a particular space. These can be written into a log to be read by a camera switching instruction set to interpret the figures for processing. The mechanisms and transfer methods are irrelevant provided that in one embodiment using two or more video cameras the arrangement of technologies produces an automated camera switching instruction set using aggregate motion analysis and point analysis, including but not limited to point motion analysis, or some combination.

To entirely automate the video production process, regardless of whether one or multiple cameras are used, a start and end time is required. This might be provided by, but is not limited to, a member of the public ordering the video, by means of an online gateway or some other suitable method using any combination of technology and data transfer, allowing that person to input the approximate start time and duration or end time of the game. Furthermore in one embodiment the system can provide the person with still picture images at intervals pre and post the time nominated as the start time of video and similarly at the approximate end time, or some reasonable variation that provides synonymous functionality, allowing the person to choose pictures which more accurately identify the start and end time of the game. The core element in this aspect being the cutting of a recorded video into a game by means of, but not necessarily limited to, an end user. Time or stamp codes might otherwise be supplied during recording or post recording so a suitably cleared administrator for the venue or any other community member such as a coach can select the start and end times for an individual event amongst all the sequentially recorded events.

To liberate coaches, or any other parties with an interest in marking up edited video, to mark-up video for the purpose of education or some other reasonable purpose, from the expertise requirement, time requirement, necessary software, logistics and the like associated with traditional methods for marking up video, the current embodiment can use, a combination of post game propriety video players, that can drop one or more of graphics, text and voice directly onto and into the video, and real time applications or web tools, that can drop graphics, text and voice directly onto or into the video, or to be synchronized, stitched in overlaid, or some other suitable method, using any suitable combination of technology and network as understood by the skilled person.

For example, in a post game process, a coach or interested individual might watch a video of the game after recording of the game, and might use a custom video player to add markers such as circles, comments and voice into said video, such that interested players or parties can subsequently watch the video with the benefit of coaching mark-ups.

For example, in a real time process, a coach might speak into a smart phone, or equivalent voice communication device, during the game event or session event, such that the smart phone interacts with the server 1.4 or 1.41 in either a streaming, synchronizing, or other suitable transfer method, such as via the Internet, as understood by the skilled person, to overlay or stitch in the voice comments into the recorded video, such that interested players or parties can subsequently watch the video with the benefit of coaching mark-ups.

The specifics of these examples does not supersede the generality of the invention such that any combination of technology and network, including but not limited, to a computer or mobile device acting through the Internet interacting with the web server 1.41, a computer or mobile device interacting through a local network with the local server 1.4, or any device or technology using any suitable data transfer method to synchronize with the video, such that interested players or parties can watch the video with the benefit of coaching mark-ups.

It should be noted that any one of the aspects mentioned above may include any of the features of any of the other aspects mentioned above and may include any of the features of any of the embodiments described below, as appropriate.

Referring to FIG. 18. The Automatic Broadcast System (ABS) uses video camera 1.1 or several video cameras 1.2, 1.3 to continuously record video of an event space, including but not limited to a sporting game held in a sport stadium 1.0, or for example held on a court, a field or any other suitable space, and send that video to local server 1.4.

Local server 1.4 either stores the raw video 1.41, compresses the raw video, or where that video is from multiple cameras uses post recording mixing processor 1.42 to convert the raw video into mixed video 1.43. Local server 1.4 might also extracts still pictures from the video, which are uploaded continuously through a Network such as the Internet 1.5 or any other suitable method to web server 1.41 or an appropriate equivalent to be used later in the video ordering process.

The mixing processor sited in video production process 3.4 automatically creates a mixing timeline 1.421, i.e. a log which describes which camera recording to use at a particular point in time in a particular game. The processes use measures of aggregate motion, i.e. the total activity within a piece of video, and measures activity within a particular section of the video, i.e. a “motion gateway”. This is useful such that in many sports the motion is spread over the entire playing surface and might be confused by referee's, crowds or other sources of motion on the field or court. Motion gateways can be placed over significant parts of the field or court, such as, but not limited to, a ring in basketball, and therefore measuring motion over that gateway, can direct Mixing Processor 1.42 to enter into mixing timeline 1.421 a camera change event at or before the motion on the gateway was detected.

This means for a example, that in the event of a ‘fast break’ or some other play where the focus suddenly and dramatically shifts ‘ends’, where aggregate motion detection would be focusing on the wrong camera, and where a direct motion gateway cue would result in switching to the correct camera only at the point when the “ball” goes through the “ring”, and therefore missing all the relevant play leading up to that shot, the present system can mark the cue, and through a timeline, instruct the mixer to take a predefined time-length of footage before that cue was detected. Thus, using a combination of motion measurements and motion cues it is possible to create a mixing timeline which interprets measures and cues to create accurate and high quality coverage of the game, or use simpler motion comparison to mix the video, or use simple one camera solutions.

Thus an ABS might continuously record content in sporting venue 1.0, and might as post recording events continuously mix that content using 1.42 into blocks of footage, e.g. five minute blocks, and might continuously record the content to local server 1.4 where it can be ordered by an interested party. Other forms of process might include raw video, which is only mixed on receiving an order 2.4.1.10, after which it can be made accessible by some suitable process to interested parties be they players 1.11, parents and friends 1.12, coaches 1.13, sport administrators 1.14 or any other individual with an interest in that video.

To make the video ‘accessible’ it needs to be cut, i.e. given a start and end time, and uploaded. It is most ideal for the start and end time to be supplied by individuals ordering the video, e.g. the coach, such that this completes the automation of the video broadcast process. However, this need not necessarily be the case, such that it might be supplied by an individual associated with the stadium, for example the stadium administrator 1.14 or some other suitable individual such as the Team captain or any of the team players.

When a party, e.g. a coach, requires to order a video, they might go to website 1.6 or use mobile application 1.10, or some other suitable gateway and run through a process as shown in FIG. 2. For example coach 1.13, might create an account 2.1.1 using registration tools 1.61 or 1.110. Once activated the coach might then setup a team 2.2.1 or some other reasonable grouping process, invite team members or interested parties to the team 2.3.1 and might order video 2.4.1 using video ordering tools 1.9, 1.19 or some other suitable equivalent.

The details collected within order process 2.4.1 must include sufficient detail to provide the relevant local server 1.4 with information to create a ‘game’ out of the recorded video on local server 1.4. This might include the coach entering a country, sport 2.4.1.1, state, stadium 2.4.1.2 or locality, court number 2.4.1.3, the date of the game 2.4.1.4 the approximate duration of the game 2.4.1.5 the approximate start of the game 2.4.1.6, or any other information which suitably instructs local server 1.4 within a multiple server system to focus on the find the relevant piece or pieces of video 1.41, 1.43, such that said interface has been variously depicted in FIG. 26.

Because sporting games, particularly amateur sporting games, start at variable times and interested parties might have poor memories or skills in terms of supplying the ‘time’ and ‘duration’ of a sporting game and sporting stadium 1.0, the inputted game time can in one embodiment, bring up a film strip of raw still pictures 1.44, illustrated in FIG. 27, now stored on web server 1.41 as part of the order process 2.4.1.7. This allows the coach, as an example, a concrete and usable mechanism to choose the first and last 2.4.1.8 frame to make up the video. The stills under this example should be some suitable length apart, e.g. 1 minute, as to provide sufficient accuracy to drive a choose start and finish video process and allow the user to order video 2.4.1.10.

At this point the system can ask for a suitable name for the video 2.4.1.9, variously depicted in FIG. 29, or can request a transaction to pay for the content or can let said user, coach or the like, order the video without paying, particularly if for example the sporting club to which said user was attached prepaid for content as part of regular fees, or if a sponsor or some other interested party pre-paid for the video.

Once an order is placed 2.4.1.10 using 1.7, 1.19 or some other suitable mechanism, it is sent either via the Network such as the Internet, or through some other suitable communicative mechanism, such as a local network connection, blue tooth connection, or any other suitable connection, to local server 1.4, where it finalizes the video delivery process described in FIG. 20 and thereby makes that video accessible to interested persons.

Depending on the state of the video in server 1.4 this ‘order’ can, instruct the upload of pieces of pre-mixed video to the web-server which relate to the particular order 2.4.1.10. It can begin a mixing process FIG. 20 outright.

The process of assembling the recorded video will now be described with reference to FIG. 20. A camera 1.1 or multiple cameras 1.3 continuously record video footage of sequential events such as individual events to local server 3.1. These streams of video are saved entirely and separately such that if seven cameras were covering a particular game, seven complete videos would be recorded to the server 3.2.1.

To facilitate the ordering process still pictures are extracted from this footage 3.2.2, from all cameras, and sent to the web-server 3.2.2.1.

Once raw footage of video is saved to the local server it can either be processed into ‘pieces’ continuously, i.e. mixed into discrete blocks 3.4 of for example five minute duration, or the raw video can be stored until an order 3.3 is received to process that piece of video. The mixing process for a system in which multiple cameras that uses two mechanisms are; firstly measures are taken of aggregate motion from a video 3.4.1, and secondly measures of gateway motion 3.4.2 are taken, these measures are used to create a camera switching time log 3.4.3 which can faithfully create a video of the game. This process can occur continuously, and the mixed outputs stored in blocks, or triggered in the event of an order, and the outputs stored either as whole files or blocks, and said blocks stitched together 3.8 on the web server. 1.41. The process may be done post recording but in some embodiments there may be a combination of real time recording and some post recording mixing using part of an existing recording such that a major part of the recording to be viewed is not in itself post recording production.

Similarly either before or after mixing, or indeed after the video has been uploaded, image overlays can be added to the video 3.5. This can take the form of brands from sponsors and any other suitable overlay. The process of uploading branding has been variously described in FIG. 5, such that a local stadium might enter an admin portal 5.1, upload a sponsor image 5.2, choose the courts and venues to which that brand is to be attached 5.3 and save the settings 5.5. This can be done through any suitable combination of gateways and networks that either upload the brand in question to the local server 1.4 or the web server 1.41, the video could even be ‘over-layed’ i.e. not stitched into the core video footage, or it might be stitched into video footage.

Thus branding might be incorporated in process 3.5 or might be incorporated later.

Similarly video might be compressed 3.6 at any point in the process but ideally after motion mixing 3.4 in order to maximize quality and minimize the size of the file or files for upload 3.7 to web server 1.41. Video outputs might be any sized file, sent up to the web-server using any reasonable method, where web-server process might perform an operation to make the video suitable for distribution. These file transfer technologies are commonplace and therefore outside the scope of the invention.

Once these steps have been completed such that the video might be recorded by a camera or cameras 1.1, 1.2, the video feeds 1.3 recorded to a local server 3.2.1 and stills might be sent to a web server to assist with ordering 3.2.1. The video itself is either mixed continuously 3.4 or an order is received 3.3, which might trigger the mixing process, and such that the process might include mechanism previously described, including but not limited to combinations of aggregate motion analysis 3.4.1 and point motion analysis 3.4.2 to create a camera switching log 3.4.3, or some equivalent mechanism and such that the mixing might not be required for a one camera system. Sponsor branding might either be overlaid within the local server 3.5 or when the video reaches the web server 1.41, the video compressed 3.6 and uploaded 3.7, in any combination of file sizes and pieces as might be reasonably effective. Once uploaded to web server 1.41, not excluding direct transfers of videos from the local server 1.4 to mobile devices, or any other suitable transfer mechanisms or methods, the video might then be accessible to interested parties.

FIG. 21 describes a process associated with playing and watching a video, which within this system might use the same interface as that associated with marking up a video, i.e. marking-up with graphics, text, voice and the like. The player, coach, parent or interested party might log into the website 1.6, where a list of all said individuals teams to which the individual has been invited under the process described in 2.3. Assuming said individual has access to a particularly team, the individual can use video viewing tools 1.8 to click on a team 4.2, to bring up the team interface FIG. 31. The team interface can provide a library of all games associated with that team, and the individual can click on any video within the library to begin playing said video. The video controls, as well as the more common ‘play’ and ‘pause’ type functions, can include controls to drop markers such as circles, lines, comments, voice or any other suitable mark up directly into the video via a click 4.5, variously depicted in FIG. 32, and save that markup 4.6, such that the next player to view said video might see both the video, and the mark-ups entered by a preceding authorized and interested party. For example the coach might play the video 4.4, click the drop circle button 4.5, the video might pause, and the coach might inspect the footage to position a circle or other suitable mark-up 4.51. The next player to view that video would see the mark-ups. A mark-up log might also be created at the bottom of the video, depicted in FIG. 31, allowing the viewer easy knowledge of what mark-ups have been performed, and quick navigation to said markups.

The preceding description describes a process by which mark-ups can be added ‘post game’. FIG. 27 describes how mark-ups can also be incorporated in real-time either by directly interfacing a local device with the local server 1.4 or by synchronization a local device to web server 1.41.

For example a smart phone can be used to record audio as a game is in progress 10.3. The audio might be either saved to the device or streamed to the server 10.4, where it can be stitched into or over-layed on the video 10.5. A public service telephone network (PSTN) can be an example of how this voice content can be delivered for recording with the video moving picture image signals.

The process can be driven by an individual downloading an application into their smart-phone, or some other suitable device, or launching a web page from their smartphone, or suitable device, 10.1 logging in and entering relevant stadium, court or any other applicable information 10.2. These are variously depicted in FIG. 29. Accordingly by speaking into the device either via a record button, voice detect mechanism, some combination, variously depicted in FIG. 30 10.3 or any other suitable means of capturing voice data on a device and either saving it to be synchronized later or streaming it directly to the local server 1.4 or web server 1.41, such that said voice is then either stitched into the video file or over-layed and played in parallel 10.5 automatically.

Referring back to FIG. 1, further aspects of the method 10 will be apparent from the above description of the system. It will be appreciated that at least part of the method will be implemented digitally by a processor. Persons skilled in the art will also appreciate that the method could be embodied in program code. The program code could be supplied in a number of ways, for example on a tangible computer readable storage medium, such as a disc or a memory or as a data signal (for example, by transmitting it from a server). Persons skilled in the art will appreciate that program code provides a series of instructions executable by the processor.

It will be understood to persons skilled in the art of the invention that many modifications may be made without departing from the spirit and scope of the invention, in particular it will be apparent that certain features of embodiments of the invention can be employed to form further embodiments.

It is to be understood that, if any prior art is referred to herein, such reference does not constitute an admission that the prior art forms a part of the common general knowledge in the art in any country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

The present application may be used as a basis for priority in respect of one or more future applications, and the claims of any such future application may be directed to any one feature or combination of features that are described in the present application. Any such future application may include one or more of the following claims, which are given by way of example and are non-limiting with regard to what may be claimed in any future application.

1. A method of providing advertising in a virtual environment comprising:
electronically associating at least one event at a location within said virtual environment;
electronically facilitating provision of advertising within said virtual environment; and
displaying said advertising to patrons of said virtual environment when said patrons traverse the virtual environment to arrive at the location of the at least one event to access the at least one event.

2. A method as claimed in claim 1, further comprising electronically associating said advertising at discrete locations within the virtual environment.

3. A method as claimed in claim 2, wherein said advertising comprises a plurality of different advertisements.

4. A method as claimed in claim 3, further comprising displaying selected ones of said plurality of different advertisements at different locations in the virtual environment.

5. A method as claimed in claim 1, wherein said advertisement comprises virtual shops at discrete locations in the virtual environment.

6. A method as claimed in claim 1, further comprising electronically associating each of the at least one event at discrete locations within said virtual environment.

7. A method as claimed in claim 6, further comprising displaying said virtual shops at discrete locations in the virtual environment to said patrons traversing the virtual environment to arrive at a location of a required one of the events.

8. A method as claimed in claim 1, wherein the virtual environment comprises a virtual stadium.

9. A method as claimed in claim 8, wherein the virtual stadium is three dimensional.

10. A system for providing advertising in a virtual environment comprising:
a server providing said virtual environment, the server being connected via a network to remote computer devices,
an association module arranged to associate at least one event at a location within said virtual environment;
an advertising module arranged to facilitate provision of advertising within said virtual environment, wherein said advertising module is further arranged to display said advertising to patrons of said virtual environment using said remote computer devices to traverse the virtual environment to arrive at the location of the at least one event to access the at least one event.

11. A system as claimed in claim 10, further comprising an output module arranged to output said at least one event to said patrons when at the respective location of the at least one event.

12. A system as claimed in claim 10, wherein the association module is further arranged to associate said advertising at discrete locations within the virtual environment.

13. A system as claimed in claim 12, wherein said advertising comprises a plurality of different advertisements.

14. A system as claimed in claim 13, wherein the advertising module is further arranged to display selected ones of said plurality of different advertisements at different locations in the virtual environment.

15. A system as claimed in claim 10, wherein the advertisement comprises virtual shops at discrete locations in the virtual environment.

16. A system as claimed in claim 10, wherein the association module is further arranged to associate each of the at least one event at discrete locations within said virtual environment.

17. A system as claimed in claim 16, wherein the advertising module is further arranged to display said virtual shops at discrete locations in the virtual environment to said patrons traversing the virtual environment to arrive at a location of a required one of the events.

18. A system as claimed in claim 10, wherein the virtual environment comprises a virtual stadium

19. A system as claimed in claim 18, wherein the virtual stadium is three dimensional.

20. Computer program code which when executed implements a method of providing advertising in a virtual environment comprising:
electronically associating at least one event at a location within said virtual environment;
electronically facilitating provision of advertising within said virtual environment; and
displaying said advertising to patrons of said virtual environment when said patrons traverse the virtual environment to arrive at the location of the at least one event to access the at least one event.
